(19) United States
(12) Patent Application Publication
(10) Pub. No.: US 2016/0286759 A1
(43) Pub. Date: Oct. 6, 2016

(54) Leg Socks for Horses

(71) Applicant: Raymond Petterson, Tallahassee, GA (US)

(72) Inventor: Raymond Petterson, Tallahassee, GA (US)

(21) Appl. No.: 14/922,702

(22) Filed: Oct. 26, 2015

Related U.S. Application Data
(63) Continuation-in-part of application No. 12/980,715, filed on Dec. 29, 2010, now abandoned.
Application No. 12/980,715 is a continuation-in-part of application No. 12/317,655, filed on Dec. 24, 2008, now abandoned.

(51) Int. Cl. A01K 13/00; A61D 7/00

(52) U.S. Cl. CPC A01K 13/007; A01K 13/003; A61D 7/00; A01K 2227/10; A01K 2227/101

(57) ABSTRACT

The present invention comprises a sock for use on the leg of a horse or ungulate, such as a cow, donkey or other hoofed animal. In the preferred embodiment the sock is tubular in shape having an upper opening and a lower opening. The sock is generally comprised of an upper cuff, main body and lower cuff. The upper cuff and main body are configured to frictionally engage creating a circumferential force on the leg of the horse such that the sock will not easily slip down on the leg of the horse. Expanded knit around the knee joint and fetlock joints allow for the free motion of those joints thus alleviating contrary forces that would normally and otherwise cause the sock to be pulled down by that motion. The lower cuff is configured to expand over said hoof of said ungulate and when over the hoof conform to or hug the small pastern.

### CROSS-REFERENCES TO RELATED APPLICATIONS

This non-provisional application is a continuation-in-part of U.S. patent application Ser. No. 12/980,715 (filed Dec. 29, 2010) which is a continuation-in-part of U.S. patent application Ser. No. 12/317,655 (filed Dec. 24, 2008). The continuation-in-part applications list the same inventor.

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

This invention relates to the field of horse leggings. More specifically, the invention comprises a sock that fits over the leg of a horse for protection or temperature regulating purposes.

2. Description of the Related Art

Horses spend a great deal of time outside in both the winter and the summer months. Due to exposure of the legs of a horse to inclement weather, insects, and plants, a horse would benefit a great deal from a leg sock. Metabolically challenged horses often have difficulty adjusting to cold temperatures. This is a health hazard for horses that have experienced founder or chronic laminitis as blood vessels in their legs and hooves are likely already damaged. This damage can worsen in cold weather, causing extreme pain and even laminitis. Keeping a horse's legs warm by using leg socks can help to keep those blood vessels working at full capacity. Leg socks can improve the very quality of a circulation-impaired horse's life. Additionally, horses suffer from a number of different medical conditions related to their legs. A properly designed leg sock can offer some relief for leg conditions such as arthritis by keeping the legs insulated from cold temperatures. The act of insulating the leg can also benefit the horse by keeping its leg warm prior to racing, jumping, or other activities, thus reducing the risk of common leg injuries. A sock for summer wear can offer further relief, by warding off flies. Flies cause horses to stomp their legs obsessively leading to cracks and splits in the wall of the hoof as well as the loss of shoes resulting in lameness or weakened hoof integrity. Additionally, flies often bile legs raw, causing infections and stopping the healing processes of wounds and injuries. Thus, a sock which offers cooling properties is desirable as well.

Previously, leg socks, braces, or wraps contained loops, snaps, zippers, straps, or other means of securing the device in place on the horse's leg. However, these attachment means can cause problems for the horse, such as if the horse gets caught in a pasture hazard because of the attachment device or if the horse handler puts the device on incorrectly causing improper constriction resulting in bowed tendons or impaired circulation. This can be detrimental to the horse's health.

Therefore it is desirable to create a sock that is easy to take on and off, which will remain secure on the horse's leg while the horse moves around and which will properly regulate temperature. The present invention achieves this objective, as well as others that are explained in the following description.

### BRIEF SUMMARY OF THE INVENTION

The present invention comprises a sock for use on the leg of a horse or other hoofed ungulates, such as a cow, mule or a donkey. In the preferred embodiment the sock is tubular in shape having an upper opening and a lower opening. The sock is generally comprised of an upper cuff, main body, and lower cuff. The upper cuff, main body and lower cuff are configured to frictionally engage the leg of the horse such that the sock will not easily slip down on the leg of the horse. The main body of sock is configured to expand specifically at the fetlock joint allowing for unimpaired motion at the joint. The expansion of the knit in main body around this joint reduces forces on the sock created by the movement of the joints, which would otherwise cause the sock to he palled down. The lower cuff is configured to expand in order to pass over the hoof of the ungulate and once clear of the hoof, then contract to conform to the smaller shape of the pastern, preventing the sock from slipping back down over the hoof.

### BRIEF DESCRIPTION OF THE SEVERAL VIEWS OF THE DRAWINGS

FIG. 1 is a perspective view, showing one embodiment of the present invention.

FIG. 2 is a perspective view, showing one embodiment of the present invention on the leg of a horse.

FIG. 3 is a perspective view, showing one embodiment of the present invention over a hoof of a horse.

FIG. 4 is a perspective view, showing one embodiment of the present invention being put on a horse.

FIG. 5 is a composite view, showing the process of a user taking one embodiment of the present invention off of a horse in FIGS. 5a, 5b and 5c respectively.

FIG. 5a is a perspective view, showing a user taking one embodiment of the present invention off of a horse.

FIG. 5b is a perspective view, showing a user taking one embodiment of the present invention off of a horse.

FIG. 5c is a perspective view, showing a user taking one embodiment of the present invention off of a horse.

FIG. 6 is a perspective view, showing the bottom cuff of the present invention.

FIG. 7 is a perspective view, showing one embodiment of the present invention.

FIG. 8 is a perspective view, showing another embodiment of the present invention.

FIG. 9 is a perspective view, showing the bottom cuff of another embodiment of the present invention.

FIG. 10 is a perspective view, showing another embodiment of the present invention.

FIG. 11 is a perspective view, showing another embodiment of the present invention.

FIG. 12 is a perspective view, showing one embodiment of the sock on the bent leg of a horse, showing forces acting on the sock as the leg bends.

FIG. 13 is a perspective view, showing another embodiment of the sock on the bent leg of a horse, showing forces acting on the sock as the leg bends.

### REFERENCE NUMERALS IN THE DRAWINGS

10 sock
12 sock
14 upper cuff
16 main body
18 lower cuff
20 horse
22 foreleg
24 hind leg
26 hoof
28 handler
30 alternate upper cuff
32 alternate lower cuff
34 knee joint
36 toe
38 walls
40 heel
42 pastern joint
44 coronet band
46 upper opening
48 lower opening
50 fetlock joint
52 hock
54 first section
56 second section
58 third section
60 front leg
62 cannon
64 alternate main body
66 foot

### DETAILED DESCRIPTION OF THE INVENTION

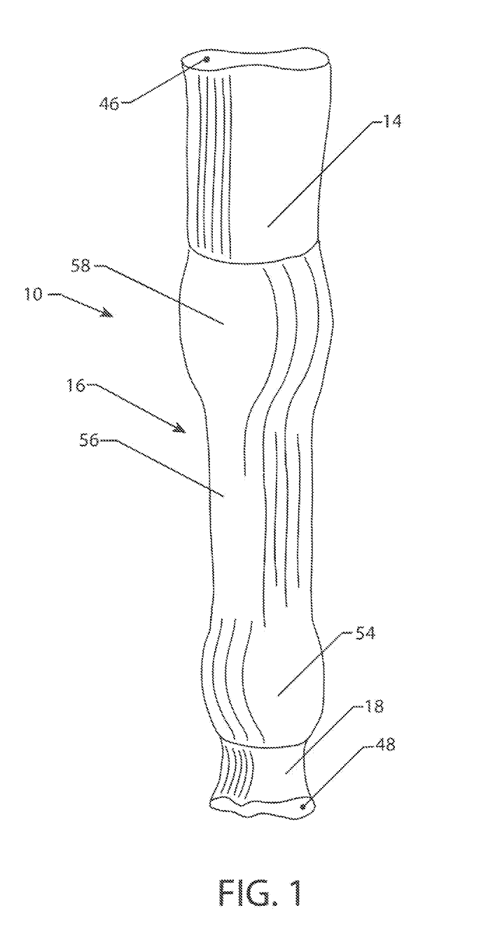

FIG. 1 illustrates the present sock 10. The sock 10 is generally comprised of upper cuff 14, main body 16, and lower cuff 18. The sock 10 is tubular in shape having a hollow center containing upper opening 46 at the top of sock 10 and lower opening 48 at the bottom of sock 10. Lower cuff 18 is located at the bottom of main body 16 and is bell-shaped. Lower cuff 18 is compactly knitted allowing lower cuff 18 to easily expand and contract. Upper cuff 18 is a more compact knit than the main body 16 knit.

As shown in FIG. 1, main body 16 is, in one embodiment, further comprised of first section 54, second section 56 and third section 58. First section 54 of main body 16 begins just above lower cuff 18, third section 58 begins just below top cuff 14 of sock 10 and second section 56 sits between first section 54 and third section 58. First section 54 and third section 58 allow for greater expansion than second section 56.

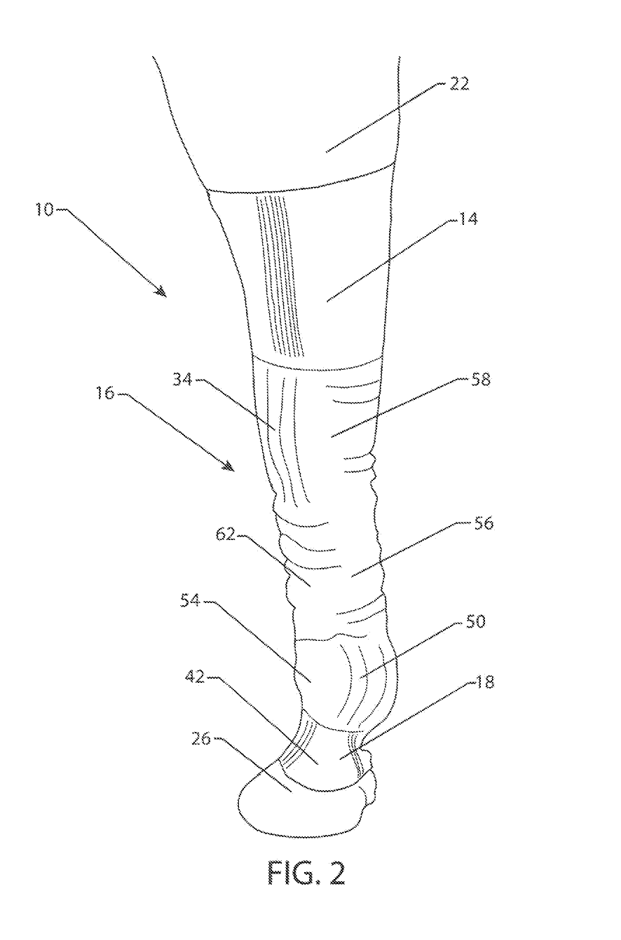

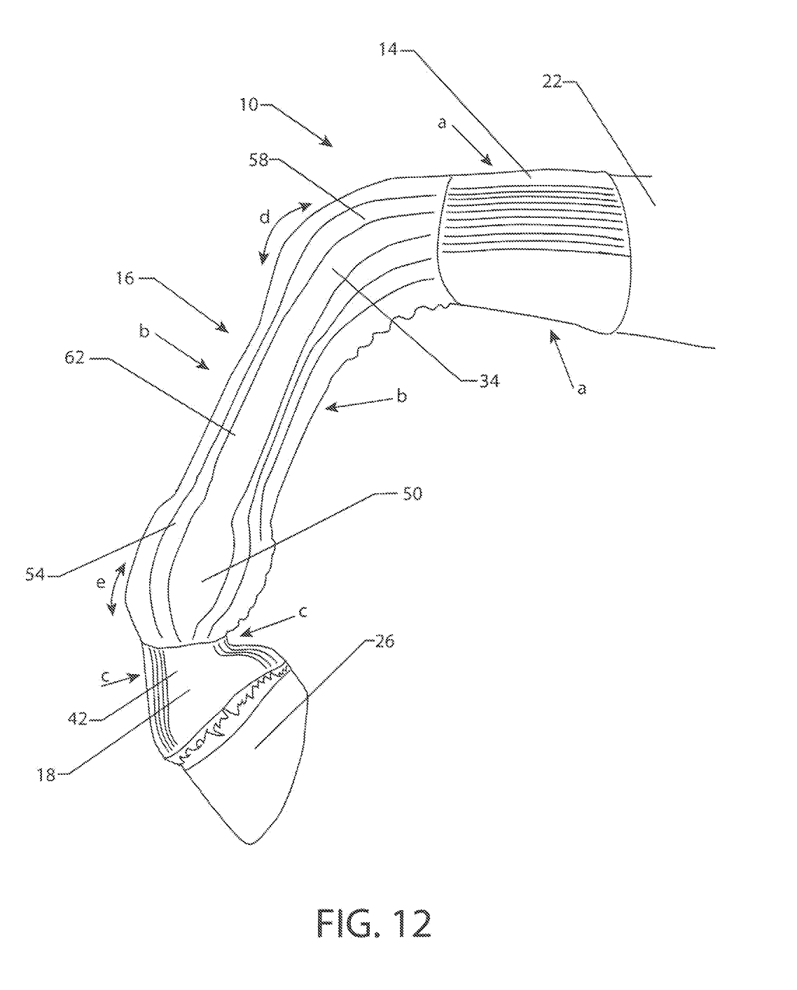

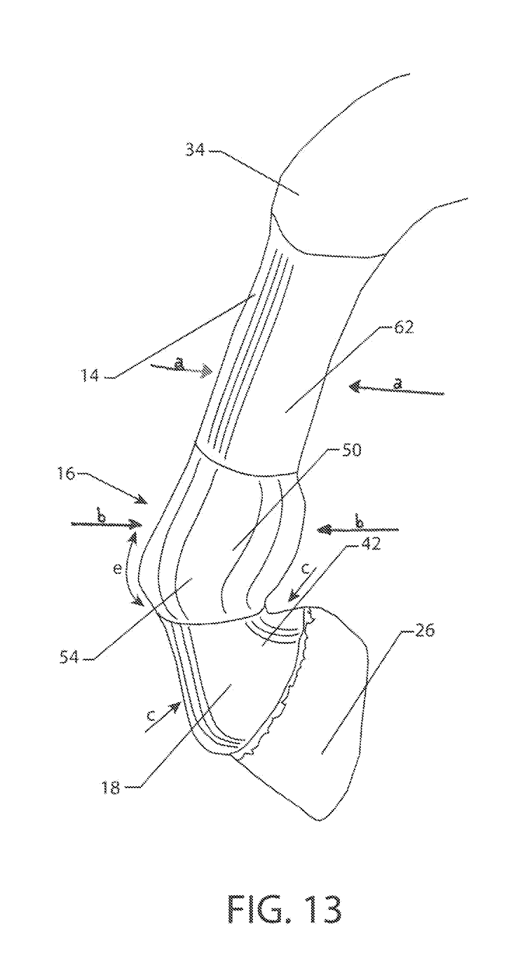

The present sock 10 is shown on a horse leg in FIG. 2. Upper cuff 14 sits above knee joint 34 in one embodiment. Main body 16 extends from the bottom of top cuff 14, covering the knee joint 34, cannon 60 and fetlock joint 50, to the top of lower cuff 18. As described above, main body 16 is comprised of three sections 54, 56 and 58 in the presently described embodiment. Third section 58 of main body 16 sits just below top cuff 14 of sock 10. Third section 58 expands around the knee joint 34 in one embodiment reducing the force on the sock created by the motion of knee joint 34 (further described in FIGS. 12 and 13). First section 54, just above lower cuff 18, expands around fetlock joint 50 and pastern 42 thereby reducing any force on sock 10 created by the motion of this joint. The expansion and reduction of force on sock 10 assists in keeping sock 10 from slipping down on cannon 60. Second section 56 expands less than first section 54 and third section 58, conforming to cannon 60 and frictionally engaging cannon 60 of horse's leg. Main body 16 of the sock 10 has a length which is greater than the total length of the cannon 60 to permit further motion in the leg without causing sock 10 to slip down cannon 60. Additionally, the added length of sock 10 in main body 16 provides the benefit of more insulation for warmth. Lower cuff 18, located directly below main body 16, expands over hoof 26 and fits comfortably on pastern 42 above hoof 26.

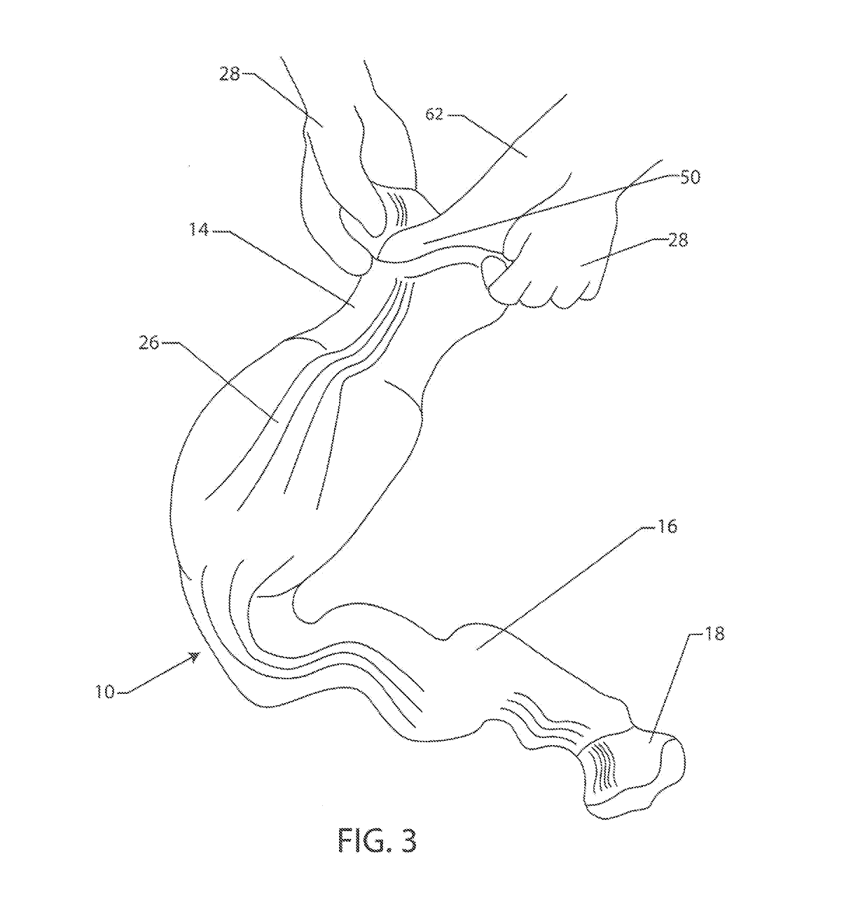

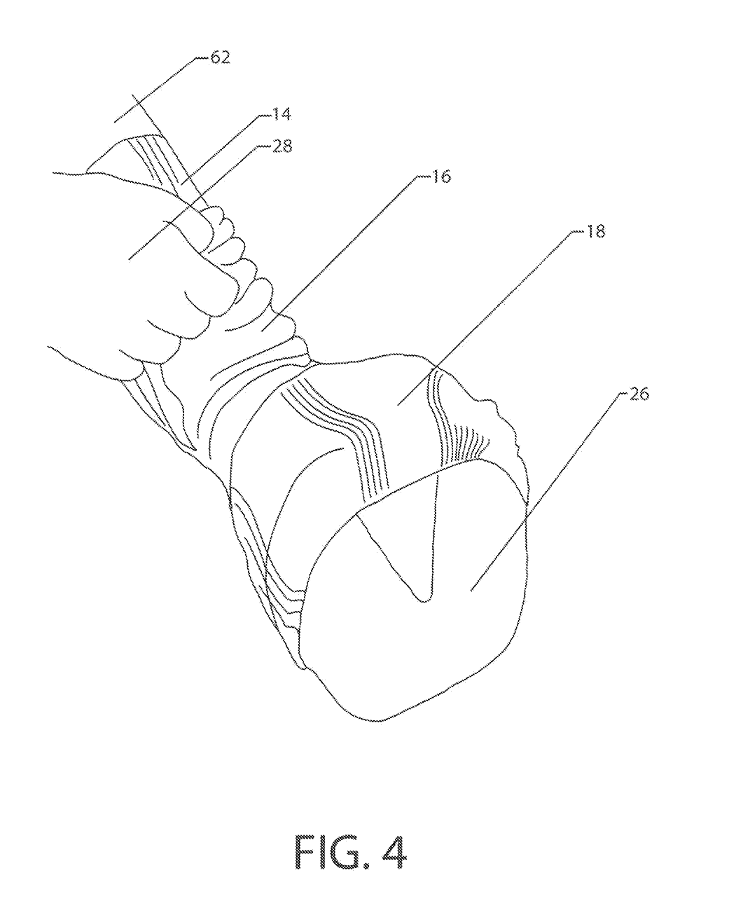

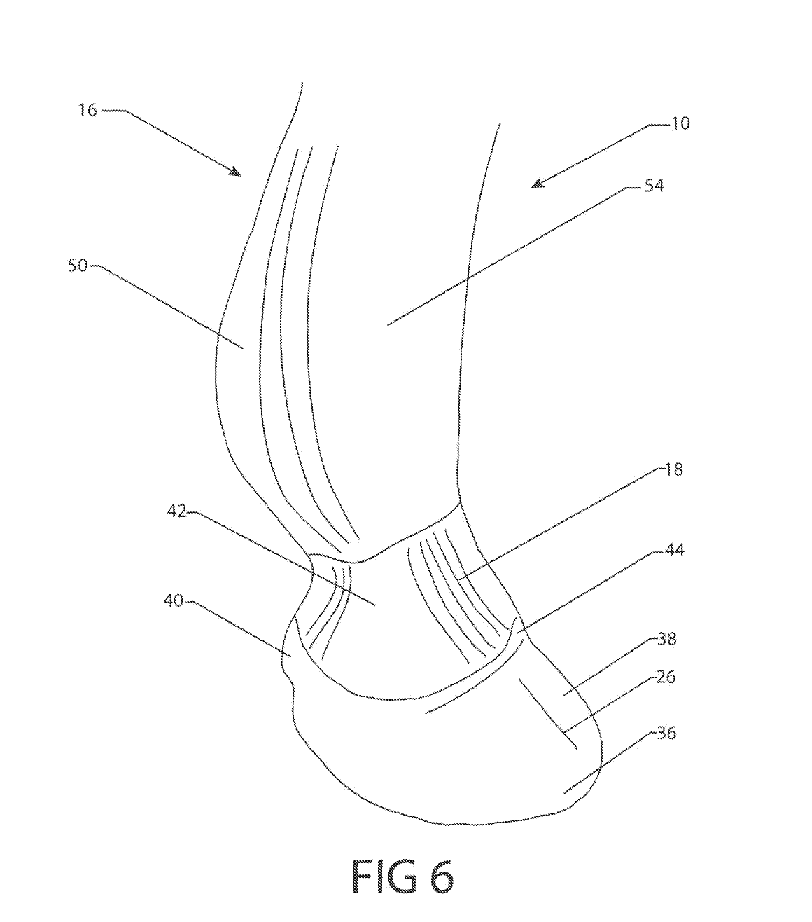

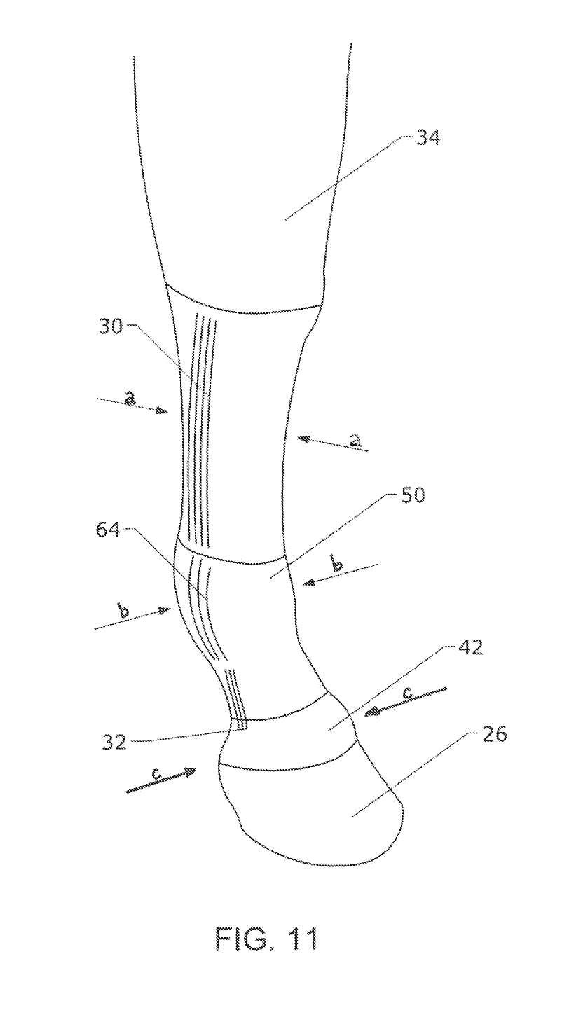

In FIG. 3 the reader can see how the present sock 10 is placed onto the leg of the horse. The horse's handler gently lifts cannon 62 and hoof 26 off of the ground, and slips upper cuff 14 followed by main body 16 over the horse's hoof 26. As illustrated in FIG. 4, lower cuff 18 easily stretches over hoof 26 as handler 28 pulls upward on the sock. However, once lower cuff 18 passes over the hoof 26 it contracts again to securely fit pastern 42, as shown in FIGS. 2 and 6. Once the sock 10 is on the horse's leg it can be easily adjusted to ensure the correct placement (shown in FIGS. 2 and 11). The absence of an attachment means, such as Velcro, snaps, loops, or ties, eliminates the risk of handler 28 applying the present sock 10 in a manner that could injure the horse by wrapping or applying the attachment means in a way that causes improper vascular constriction or tendon constriction. Additionally, the absence of an attachment means reduces the risk of injury If the sock becomes tangled in a potential pasture hazard, such as fencing debris, thereby otherwise causing damage to the horse's leg. The present sock 10 is designed to slip off leg 22 if the sock 10 gets caught up in any significant external hazard.

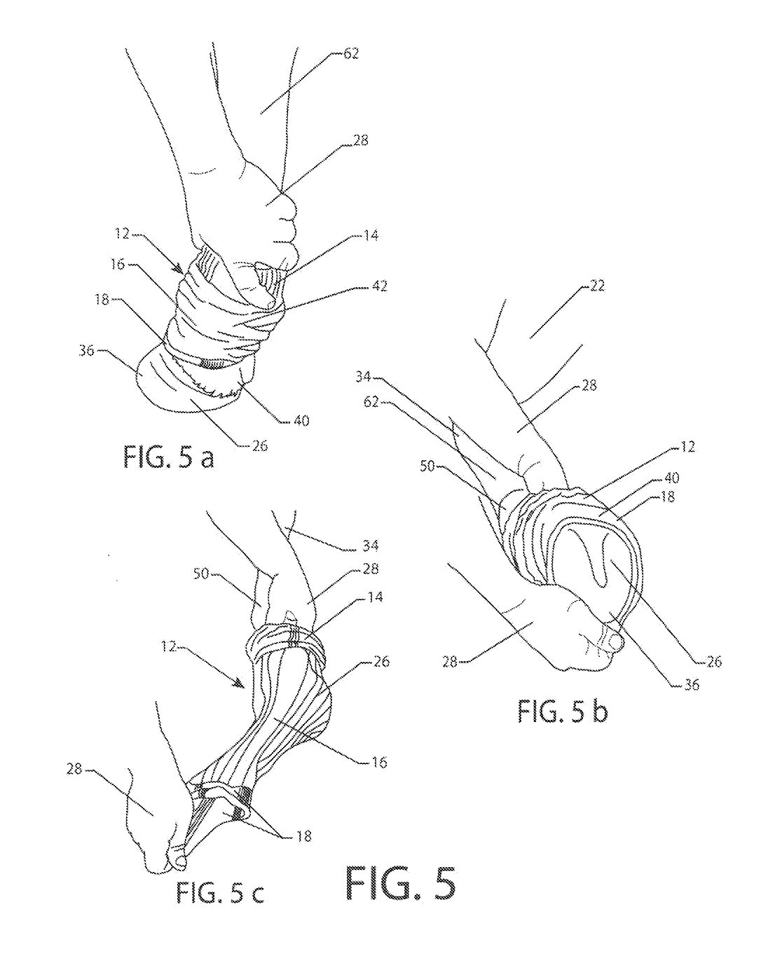

FIG. 5a-c shows the manner in which handler 28 removes sock 10 from the horse's leg 22. While one embodiment of sock 10 is shown, the manner of removing the other embodiment of sock 12 (shown in FIG. 11) is identical in nature. First, as shown in FIG. 5a handler 28 pushes sock 10 down on horse's cannon 62 towards hoof 26. Sock 10 bunches together considerably, naturally expanding as sock 10 is pressed downward. Next, as shown in FIG. 5b handler 28 gently lifts hoof 26 off of the ground grasping sock 10 at its base approximate to lower cuff 18 and pulling sock 10 over hoof 26. As handler 28 pulls sock 10 lower cuff 18, main body 16 and eventually upper cuff 14 slip off of the horse's leg with case, as illustrated in FIG. 5c.

FIG. 6 illustrates lower cuff 18 and its location on the horse's pastern 42. As illustrated, a horse's hoof 26 contains toe 36 and heel 40, coronet band 44, and walls 38. Lower cuff 18 covers pastern 42 and ends just above coronet band 44. Lower cuff 18 acts to prevent main body 16 from slipping over walls 38, toe 36, and heel 40.

FIG. 2 shows upper cuff 14 located just above the knee joint 34. Since upper cuff 14 has a denser knit and greater level of elasticity than the body of sock 10, and because the knit is expanded around the knee joint 34 and fetlock joint 50, allowing free motion of the sock around those joints, sock 10 stays in place for extended periods of time. This is due to the fact that the forces created by the fictional engagement of the sock with foreleg 22, cannon 62 and pastern 42 are greater than the forces acting on sock 10, including those created by the motion of the joints and gravity itself. As illustrated in FIG. 6, lower cuff 18 is located in the reduced diameter of the pastern 42. Lower cuff 18 would have to expand to move up onto the fetlock joint 50 or down onto the hoof 26. Thus lower cuff 18 contributes to hold the sock in place. Again, the expansion of first section 54 of main body 16 over fetlock joint 50 joint permits the sock 10 to easily move with fetlock joint 50 as the horse moves, greatly assisting with keeping sock 10 in place.

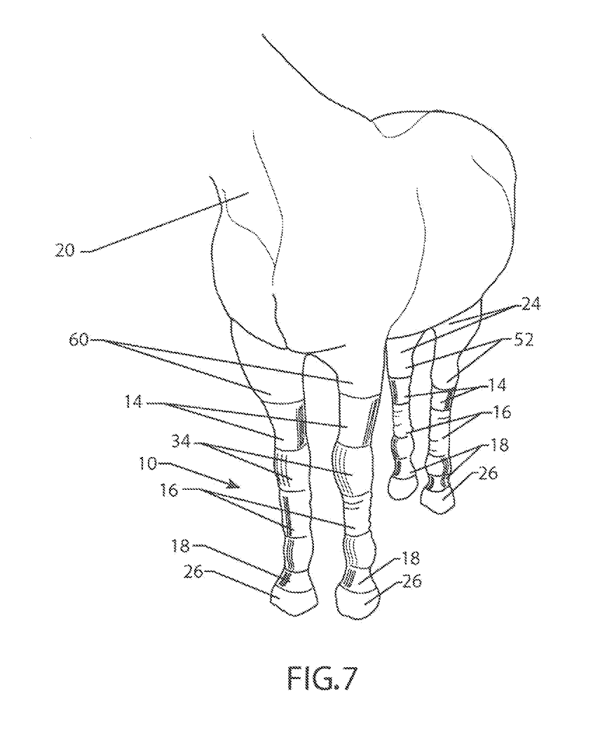

The present sock 10 is shown in FIG. 7 on both front legs 60 and hind legs 24 of the horse 20. On front legs 60 upper cuffs 14 of socks 10 are pulled above knee joint 34. However, on the horses hind legs 24, upper cuffs 14 sit just below the horse's hocks 52. As shown, a large proportion of the horse's four legs are covered by the present socks 10. This benefits the horse by keeping the legs warm in the winter or before or after strenuous activity and by protecting the legs from insects and minor scratches from branches or brush.

In the present embodiment, sock 10 is knitted from a yarn that has the ability to insulate the horse's leg, and frictionally engage the horse's leg while avoiding constriction of the leg or compromising circulation in any manner. One example of a yarn containing these properties would be a yarn containing, cotton, acrylic, wool, polyester, nylon, elastand (spandex), nylon Lycra and/or elastic hydrocarbon polymer (rubber), in the preferred embodiment the fibers contain FOSSHIELD® fiber technology (as discussed below). Main body 16 of the present sock 10 can be knitted using various sizes and density of cable knit stitch, in which the order of the stitches is permuted, to utilize as much yarn as necessary in order to create optimum insulation, protection and strength. Knit density, cross stretch, and levels of elasticity are changed through out the sock knitting process to provide optimum fit “stay put” qualities and insulation for warmth and protection. By controlling the number of ends of yarns, the density of the stitch, the number of ends of elastic yarns, the tension or lack of tension of the yarn feeds, the plaiting of the yarns in concert with each other and the dimensional sizes of the various yarns, the present sock 10 expands as needed to be put on or taken, off, while frictionally engaging with the leg to offer “stay put” qualities and optimum fit, warmth and protection.

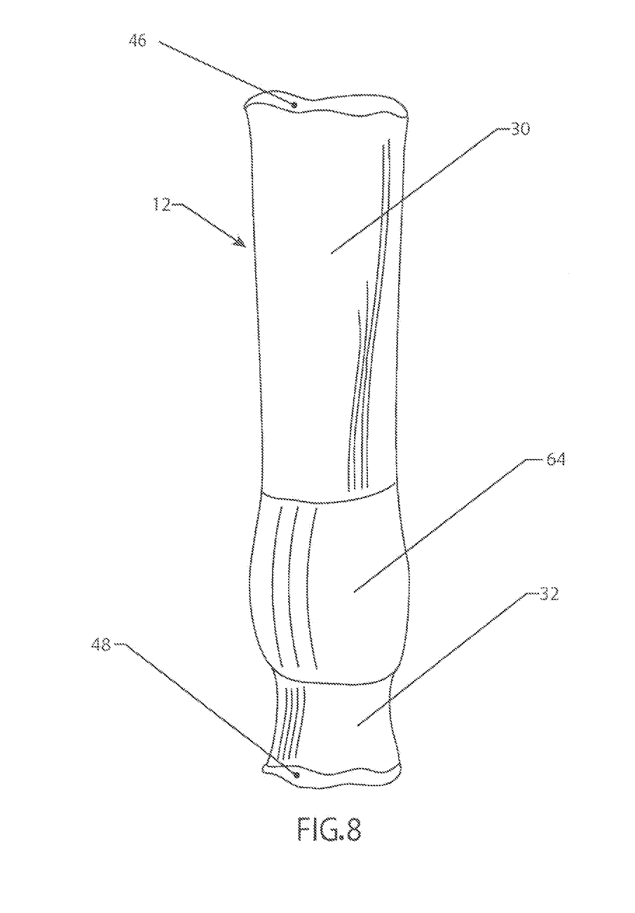

Another embodiment of the present invention is shown in FIG. 8. In this embodiment, sock 12 is comprised of upper cuff 30, main body 64 and lower cuff 32. Sock 12 is illustrated in FIG. 11 on the leg of a horse. Upper cuff 30 conforms to the shape of cannon 62 and is held in place by a circumferential frictional engagement Upper cuff 30 applies biaxial compression to the leg of the horse and sits just below knee joint 34. Lower cuff 32 is still present as described in the prior embodiment, conforming to the pastern joint 42 and covering a portion of the hoof 26. Main body 64 is comprised of one expanded portion, which expands around fetlock joint 50 and allows sock 12 to move freely with the movement of fetlock joint 50. The motion encouraging properties of alternate main body 64 prevent sock 12 from being pulled down on the leg of the horse every time the leg bends.

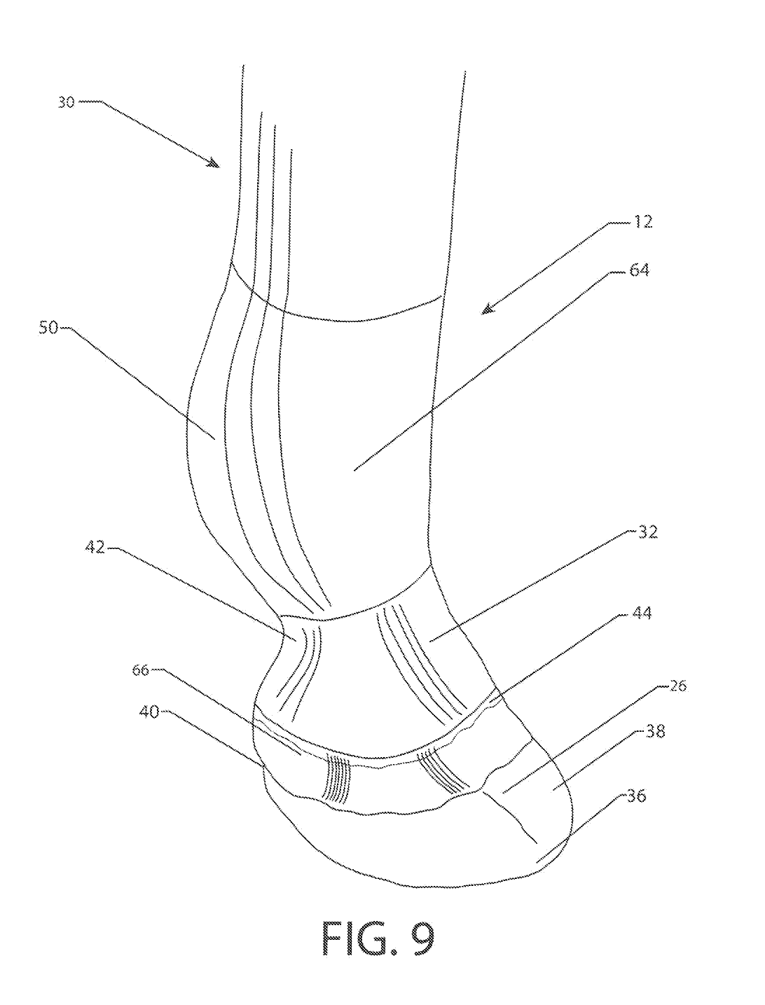

As shown in FIG. 9, lower cuff 32 still expands easily and fits comfortably over small pastern 42 without causing unnecessary constriction. Again, lower cuff 32 comes to a rest just above coronet hand 44 (while coronet band 44 would not normally be visible through sock 12 it is shown here for purposes of illustrating the location of lower cuff 32 on the horse's leg). An optional foot 66 may be added in the form of a flat knit, loose fitting, bell shaped covering to add protection from flies to the coronet band 44. Foot 66 does not change or modify any of the properties of lower cuff 32.

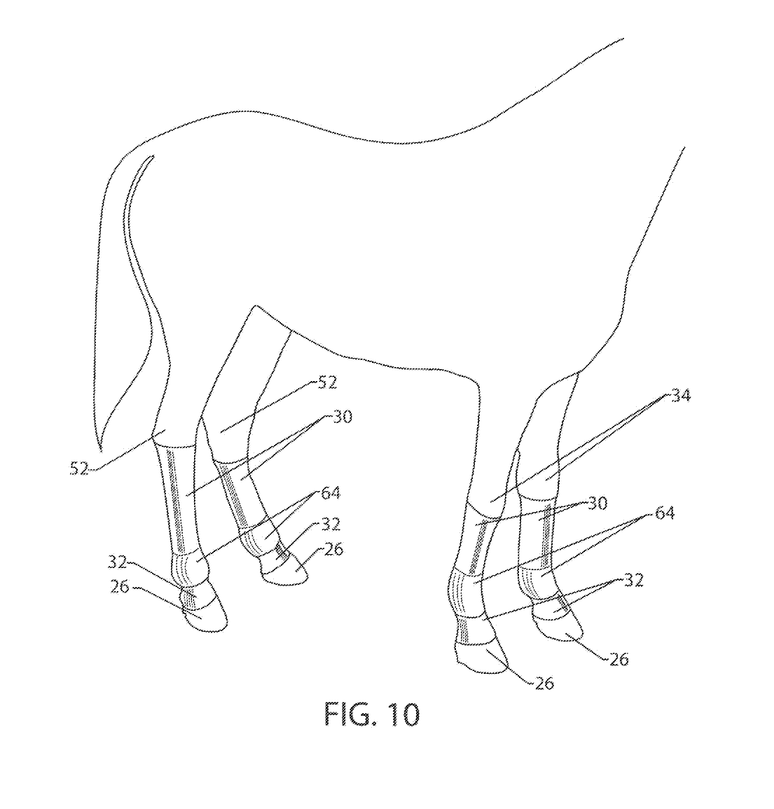

FIG. 10 illustrates the placement of the embodiment of socks 12 at the knees 34 and hocks 52 of horse 20. Socks 12 are held in place by frictional engagement and kept in place by the properties of expansion built into main body 64 of sock 12. It is important that no straps, buttons, snaps, loops or Velcro are used to attach or constrict the socks 12 to the horse's legs. FIG. 11 illustrates the compressive force applied to a horse's leg by this embodiment of the sock. The upper cuff 36 provides a first amount of biaxial compression (shown as a) on the leg of the horse that is greater than a second amount of biaxial, compression (shown as b) on the leg of the horse that is provided by main body 64 (when measured at points of equal circumference and at the relevant points of coverage of a horse's leg). Therefore, sock 12 is held in place solely by fractional engagement caused by the biaxial compression of sock. An additional third amount of biaxial compression (shown as c) on the leg of the horse is provided by lower cuff 32. The third amount of compression (c) is less than the first, amount of biaxial compression (a).

Additionally, this embodiment can be knitted from various materials. However, one good approach is to use a yarn treated with a FOSSHIELD® fiber treatment in which the fibrous material, or yarn in the present embodiment, is embedded with silver and copper ions. Foss Manufacturing Company, LLC, of Hampton, N.H. developed FOSSHIELD® fabric technology which safely and naturally inhibits the growth of destructive and odor-causing bacteria, fungi, and mold, in the socks. The use of FOSSHIELD® fabric technology allows for a clean environment around the leg of the horse.

The present embodiment of sock 12 is preferably knitted from a yarn that has the ability to wick moisture from the horse's leg thereby keeping the leg cool. An example of a yarn containing these properties would be a yarn comprised of a blend of polyester, elastand (spandex), elastic hydrocarbon polymer (rubber) and treated with FOSSHIELD® fiber technology (as discussed above).

FIG. 12 illustrates several forces acting upon the embodiment of the sock depicted in FIGS. 1-2. As illustrated, upper cuff 14 conforms to foreleg 22 of horse, creating a first force (shown by arrows labeled a) upon sock 10, assisting in holding sock 10 in the desired position on the horse's leg. While the arrows labeled (a) show an inward force as first force, the reader will appreciate that the force is a circumferential inward force (biaxial compression) acting all around the leg at upper cuff 14. Second section 56 of main body 16 conforms to cannon 62, creating a second force (shown by arrows labeled b) upon sock 10, also assisting in holding sock 10 in the desired position on the horse's leg (again this force is circumferential). The first force is greater than second force. Finally, lower cuff 18 conforms to pastern 42, creating a minimal third force (shown by arrows labeled c) upon sock 10, assisting in holding sock 10 in the desired position on the horse's leg, in this case, primarily assisting in positioning the sock 10 such that it will not slip over hoof 26 nor rise above fetlock joint 50 (again, the force is circumferential). The primary forces acting to hold sock 10 in the desired position on the leg of the horse are counteracted by secondary contrary forces. While gravity acts as a secondary force on the sock, its effect is minimal and therefore is greatly outweighed by the primary forces (a, b and c) discussed above which hold the sock in place. The secondary forces that are encountered are primarily from the movement of the horse, which in prior art socks acts to poll the sock in one direction or another, moving the sock out of the desired position or off of the leg entirely. The present design minimizes those secondary forces by creating a sock which allows for the movement of the sock around the relevant joints. As illustrated, third section 58 of main body 16 expands around knee joint 34. The motion of knee joint 34 creates a first contrary force (shown as arrows labeled d) acting to pull sock 10 out of its desired position. Further, the motion of fetlock joint 50 creates a second contrary force (shown as arrows labeled e) acting again to pull sock 10 out of its desired position. The first and second contrary force are minimized due to the expansion properties of sock 10 at first section 54 around fetlock joint 50 and third section 58 around knee joint 34. Thus, the sum of the forces holding the sock in its desired position is greater than the sum of the contrary forces acting to pull the sock out of its desired position thereby causing sock 10 to remain in position on the leg of the horse.

Similarly the relevant forces acting upon sock 12 in the embodiment shown in FIG. 11 are discussed and further illustrated in FIG. 13. Upper cuff 14 conforms to cannon 62 of horse, creating a first amount of biaxial compression (shown by arrows labeled a) on the leg of the horse, which is primarily responsible for holding sock 10 in the desired position on the horse's leg. A secondary contrary force (e) is created by the motion of fetlock joint 50. Main body 16 expands around fetlock joint 50 thereby reducing the secondary contrary force. The sum total of the contrary forces is less than the first amount of biaxial compression, primarily acting to hold sock 12 in the desired position on the horse's leg. Additionally, as shown main body 64 and lower cuff 18 provides a second amount of biaxial compression and a third amount of biaxial compression (shown by arrows labeled b and c) acting on the fetlock joint 50 and pastern 42 which provides additional, support to sock 12.

The preceding description contains significant detail regarding the novel aspects of the present invention. It should not be construed, however, as limiting the scope of the invention but rather as providing illustrations of the preferred embodiments of the invention. As an example, upper cuff 14 and main body 16 can be knitted in the same manner thereby effectively eliminating the appearance of an upper cuff 14. Additionally, main body 16 can include one or two expandable sections. Thus, the scope of the invention should be fixed by the following claims, rather than by the examples given.

Having described my invention, I claim:

1. A sock having a tubular shape for use on a leg of an ungulate, wherein said ungulate has a hoof, a knee joint, a fetlock joint and a pastern on said leg, wherein said leg and said pastern have a diameter, wherein said sock maintains a position on said leg of said ungulate, comprising:
a. an upper cuff having a lower end and an upper end:
i. wherein said upper end of said upper cuff is positioned below said knee joint and further comprises an upper opening;
ii. wherein said upper cuff is configured to frictionally engage with said leg of said ungulate providing a first amount of biaxial compression on said leg of said ungulate, wherein said first amount of biaxial compression assists in maintaining said position of said sock on said leg of said ungulate; and
iii. wherein said upper cuff is configured to expand sufficiently to fit over said hoof;
b. a main body:
i. wherein said main body is connected to said lower end of said upper cuff;
ii. wherein said main body is hollow;
iii. wherein said main body is configured to expand sufficiently to fit over said hoof;
iv. wherein said main body provides a second amount of biaxial compression on said leg of said ungulate that is less than said first amount of biaxial compression provided by said upper cuff; and
v. wherein said main body is configured to expand around said fetlock joint to allow a motion of said fetlock joint;
c. a lower cuff having an upper end and a lower end:
i. wherein said upper end of said lower cuff is connected to said main body;
ii. wherein said lower cuff is configured to expand over said hoof;
iii. wherein said lower cuff conforms to said pastern of said ungulate and provides a third amount of biaxial compression on said leg of said ungulate; and
iv. wherein said lower end of said lower cuff has a lower opening.

2. A sock as recited in claim 1, wherein said sock is comprised of a plurality of strands of yarn.

3. A sock as recited in claim 2, wherein said plurality of strands of yarn are selected from a group comprising:
a. acrylic;
b. wool
c. polyester;
d. nylon;
e. elastand; and
f. elastic hydrocarbon polymer.

4. A sock as recited in claim 3, wherein said plurality of strands of yarn contain fibers having antimicrobial properties.

5. A sock as recited in claim 1, wherein said sock is held in place on said leg of said ungulate solely by said first, second and third amounts of biaxial compression provided to said leg of said ungulate.

6. A sock as recited in claim 1, wherein said upper cuff and said lower cuff have a diameter in a relaxed state, wherein said diameter of said upper cuff in said relaxed state is smaller than said diameter of said leg of said ungulate and wherein said diameter of said lower cuff in said relaxed state is smaller than said diameter of said pastern.

7. A sock as recited in claim 1, wherein said sock further comprises a foot, wherein said foot is attached to said lower cuff and covers a portion of said hoof of said ungulate.

8. A sock having a tubular shape for use on a leg of an ungulate, wherein said ungulate has a hoof, a hock joint, a fetlock joint and a pastern on said hind leg, wherein said leg and said pastern have a diameter, wherein said sock maintains a position on said leg of said ungulate, comprising:
a. an upper cuff having a lower end and an upper end:
i. wherein said upper end of said upper cuff is positioned below said hock joint and further comprises an upper opening;
ii. wherein said upper cuff is configured to frictionally engage with said leg of said ungulate providing a first amount of biaxial compression on said leg of said ungulate, wherein said first amount of biaxial compression assists in maintaining said position of said sock on said leg of said ungulate; and
iii. wherein said upper cuff is configured to expand sufficiently to fit over said hoof;
b. a main body:
i. wherein said main body is connected to said lower end of said upper cuff;
ii. wherein said main body is hollow;
iii. wherein said main body is configured to expand sufficiently to fit over said hoof;
iv. wherein said main body provides a second amount of biaxial compression on said leg of said ungulate that is less than said first amount of biaxial compression provided by said upper cuff; and
v. wherein said main body is configured to expand around said fetlock joint to allow a motion of said fetlock joint;
c. a lower cuff having an upper end and a lower end:
i. wherein said upper end of said lower cuff is connected to said main body;
ii. wherein said lower cuff is configured to expand over said hoof;
iii. wherein said lower cuff conforms to said pastern of said ungulate and provides a third amount of biaxial compression on said leg of said ungulate; and
iv. wherein said lower end of said lower cuff has a lower opening.

9. A sock as recited in claim 8, wherein said sock is comprised of a plurality of strands of yarn.

10. A sock as recited in claim 9, wherein said plurality of strands of yarn are selected from a group comprising:
a. acrylic;
b. wool
c. polyester;
d. nylon;
e. elastand; and
f. elastic hydrocarbon polymer.

11. A sock as recited in claim 10, wherein said plurality of strands of yarn containing fibers having antimicrobial properties.

12. A sock as recited in claim 8, wherein said sock is held in place on said leg of said ungulate solely by said first, second and third amounts of biaxial compression provided to said leg of said ungulate.

13. A sock as recited in claim 8, wherein said upper cuff and said lower cuff have a diameter in a relaxed state, wherein said diameter of said upper cuff in said relaxed state is smaller than said diameter of said leg of said ungulate and wherein said diameter of said lower cuff in said relaxed state is smaller than said diameter of said pastern.

14. A sock as recited in claim 8, wherein said sock further comprises a foot, wherein said foot is attached to said lower cuff and covers a portion of said hoof of said ungulate.

15. A sock having a tubular shape for use on a leg of an ungulate, wherein said ungulate has a hoof, a knee joint, a fetlock joint and a pastern on said leg, wherein said leg and said pastern have a diameter, wherein said sock maintains a position on said leg of said ungulate, comprising:
a. an upper cuff having a lower end and an upper end:
i. wherein said upper end of said upper cuff is positioned below said knee joint and further comprises an upper opening;
ii. wherein said upper cuff is configured to frictionally engage with said leg of said ungulate providing a first amount of biaxial compression on said leg of said ungulate;
iii. wherein said upper cuff is configured to expand sufficiently to fit over said hoof;
b. a main body:
i. wherein said main body is connected to said lower end of said upper cuff;
ii. wherein said main body is hollow;
iii. wherein said main body is configured to expand sufficiently to fit over said hoof;
iv. wherein said main body frictionally engages with said leg of said ungulate and provides a second amount of biaxial compression on said leg of said ungulate that is less than said first amount of biaxial compression provided by said upper cuff; and
v. wherein said main body is configured to expand around said fetlock joint to allow a motion of said fetlock joint;
e. a lower cuff having an upper end and a lower end:
i. wherein said upper end of said lower cuff is connected to said main body;
ii. wherein said lower cuff is configured to expand over said hoof;
iii. wherein said lower cuff conforms to said pastern of said ungulate and provides a third amount of biaxial compression on said leg of said ungulate; and
iv. wherein said lower end of said lower cuff has a lower opening.
